(19) United States
(12) Patent Application Publication
(10) Pub. No.: US 2018/0284221 A1
(43) Pub. Date: Oct. 4, 2018

(54) RADAR APPARATUS

(71) Applicant: Panasonic Intellectual Property Management Co., Ltd., Osaka (JP)

(72) Inventor: YOSHIYUKI SAITO, Kanagawa (JP)

(21) Appl. No.: 15/924,740

(22) Filed: Mar. 19, 2018

(30) Foreign Application Priority Data
Mar. 28, 2017 (JP) 2017-063024

(51) Int. Cl. G01S 7/40; G01S 13/32

(52) U.S. Cl. CPC G01S 7/40; G01S 13/32

(57) ABSTRACT

An embodiment of the present disclosure provides a radar apparatus including a transmission antenna unit that radiates measurement waves to a certain direction, a receiving antenna unit that receives return waves from one or more objects around the radar apparatus, a dielectric unit that covers at least one of a front of the transmission antenna unit and a front of the receiving antenna unit, a signal processor that at least calculates a distance to the one or more objects based on the return waves, and a corrector that corrects the distance based on a relative permittivity and a thickness of the dielectric unit.

### BACKGROUND

### 1. Technical Field

The present disclosure relates to a radar apparatus using microwaves or millimeter waves.

### 2. Description of the Related Art

In recent years, various sensors are mounted in vehicles in order to detect objects around the vehicles. Among the various sensors, radar apparatuses using the microwaves or the millimeter waves have the advantage in that not only the moving speeds of objects are capable of being accurately measured, in addition to the distances to the objects and the direction of the objects, but also the objects are capable of being detected even in bad weather. The radar apparatuses also have the advantage in that the appearances of the vehicles are not affected by the radar apparatuses because the radar apparatuses are capable of being mounted in the bumpers or the emblems of the vehicles.

In the case of a millimeter-wave radar apparatus, for example, radio waves of a 24-GHz band, a 77-GHz band, or a 79-GHz band are transmitted. The millimeter-wave radar apparatus receives radio waves (return waves) reflected from an object around the apparatus to calculate the distance to the object or the relative speed of the object from the difference between the transmitted waves and the return waves.

The radar apparatuses adopt some systems. Among the systems, a frequency modulated continuous wave (FMCW) system or a pulse system (pulse Doppler system) is mainly used by the radar apparatuses.

In the FMCW system, transmitted waves subjected to frequency modulation are mixed with received waves to generate a beat signal and the distance to an object or the relative speed of the object is calculated from the beat signal.

In the pulse system, the distance to an object or the relative speed of the object is calculated from the correlation and the phase difference between transmitted waves subjected to pulse modulation and received waves.

A typical in-vehicle radar apparatus developed using either of the above systems is capable of detecting an object apart from the vehicle by up to about 250 m and has a high range resolution of several centimeters to several tens of centimeters. However, it is difficult for the radar apparatus to detect an object located within a close range closer than or equal to several meters (for example, 1 m) with high accuracy due to noises. In addition, since the oscillation frequency of a built-in oscillator is temporally varied in the radar apparatus, there is a problem in the accuracy in the detection distance in terms of frequency stability.

In order to resolve the above problems, a technology is proposed in which a millimeter-wave oscillator is configured using a frequency stabilized Gunn oscillator to reduce a measurement error caused by variation in frequency and carrier waves of a millimeter-wave band are modulated using a high-speed operating element, such as a field-effect transistor (FET), to realize the measurement error of about several centimeters. However, since the expensive high-speed operating element is required in this technology, an increase in the cost of the radar apparatus may be caused. For example, refer to Japanese Unexamined Patent Application Publication No. 2000-258525.

### SUMMARY

One non-limiting and exemplary embodiment facilitates providing a radar apparatus capable of being configured at a lower cost.

In one general aspect, the techniques disclosed here feature a radar apparatus including a transmission antenna unit that radiates measurement waves to a certain direction, a receiving antenna unit that receives return waves from one or more objects around the radar apparatus, a dielectric unit that covers at least one of a front of the transmission antenna unit and a front of the receiving antenna unit, a signal processor that at least calculates a distance to the one or more objects based on the return waves, and a corrector that corrects the distance based on a relative permittivity and a thickness of the dielectric unit.

According to the present disclosure, it is possible to provide a radar apparatus capable of being configured at a lower cost, compared with that in the related art.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating an exemplary configuration of a radar apparatus according to a first embodiment;

FIG. 2 is a schematic diagram illustrating an exemplary configuration of a transmission antenna unit and a receiving antenna unit according to the first embodiment;

FIG. 3 illustrates a measurement principle of the radar apparatus illustrated in FIG. 1;

FIG. 4 is a block diagram illustrating an exemplary configuration of a radar apparatus according to a second embodiment;

FIG. 5 is a schematic diagram illustrating part of the radar apparatus illustrated in FIG. 4;

FIG. 6 is a schematic diagram illustrating part of a radar apparatus according to a third embodiment; and

FIG. 7 is a schematic diagram illustrating a process performed by a correction unit when an object is located diagonally in front of a radar apparatus.

### DETAILED DESCRIPTION

Radar apparatuses of the present disclosure will herein be described with reference to the drawings.

### 1. Definition

Table 1 indicates the meanings of acronyms and abbreviations used in the following description:

TABLE 1

| Acronyms, etc. | Meanings |
|---|---|
| FMCW | Frequency Modulated Continuous Wave |
| MIMO | Multiple-input and Multiple-output |
| CMOS | Complementary Metal Oxide Semiconductor |
| LSI | Large-Scale Integration |

### 2. First Embodiment

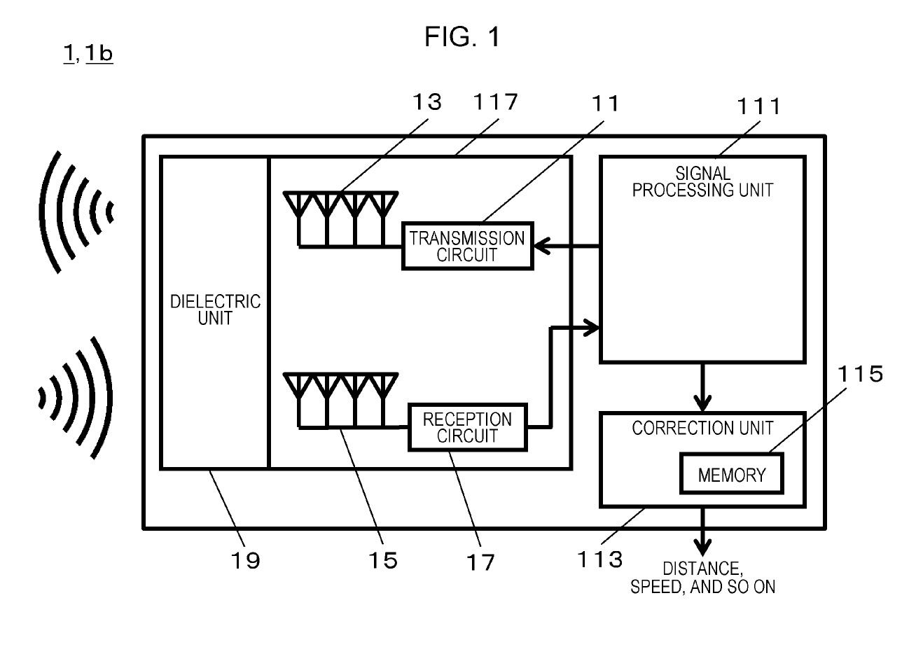

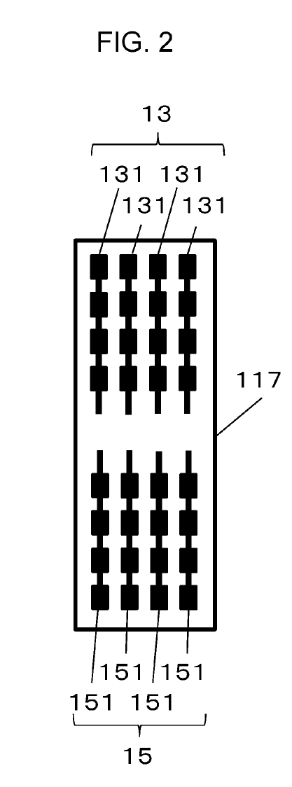

An exemplary configuration of a radar apparatus 1 of a first embodiment of the present disclosure will now be described with reference to FIG. 1 and FIG. 2.

### 2-1. Configuration of Radar Apparatus

Referring to FIG. 1 and FIG. 2, the radar apparatus 1 is, for example, an FMCW radar apparatus and includes a transmission circuit 11, a transmission antenna unit 13, a receiving antenna unit 15, a receiving circuit 17, a dielectric unit 19, a signal processing unit 111, and a correction unit 113.

The transmission circuit 11 supplies continuous waves (hereinafter referred to as an FMCW signal) that are subjected to frequency modulation so that the frequency of the continuous waves is linearly increased on a unit cycle to the transmission antenna unit 13 and the receiving circuit 17.

The transmission antenna unit 13 is, for example, an antenna array including multiple antenna elements and is provided on the surface of a substrate 117. In an example in FIG. 2, the transmission antenna unit 13 includes four antenna branches 131 each including the multiple antenna elements. The transmission antenna unit 13 may include the antenna branches 131 of a number other than four.

The transmission antenna unit 13 radiates the FMCW signal supplied from the transmission circuit 11 to the periphery of the radar apparatus 1 as measurement waves. For example, a millimeter-wave band is selected as the frequency of the measurement waves. The measurement waves from the transmission antenna unit 13 are reflected from an object that can be located within a measurement range of the radar apparatus 1. Part of such reflected waves is received by the receiving antenna unit 15 as return waves.

The receiving antenna unit 15 is, for example, an antenna array including multiple antenna elements and is provided on the surface of the substrate 117. In the example in FIG. 2, the receiving antenna unit 15 includes four antenna branches 151 each including the multiple antenna elements. The receiving antenna unit 15 may include the antenna branches 151 of a number other than four.

An example is illustrated in FIG. 2 in which the transmission antenna unit 13 is disposed vertically above the receiving antenna unit 15. However, the disposition of the transmission antenna unit 13 is not limited to this and the transmission antenna unit 13 may be disposed vertically below the receiving antenna unit 15. Alternatively, the transmission antenna unit 13 and the receiving antenna unit 15 may be disposed so as to be horizontally adjacent to each other.

Although each antenna element has a rectangular planar shape in the example in FIG. 2, the antenna element may have another shape.

Alternatively, the transmission antenna unit 13 and the receiving antenna unit 15 may have a MIMO configuration.

The receiving antenna unit 15 supplies a signal indicating the strength and the frequency of the received return waves on a time axis to the receiving circuit 17.

The receiving circuit 17 performs frequency mixing of the FMCW signal supplied from the transmission circuit 11 with the signal output from the receiving antenna unit 15 to generate a beat signal. The receiving circuit 17 supplies the generated beat signal to the signal processing unit 111.

The signal processing unit 111 includes, for example, a signal processing LSI composed of a CMOS and controls transmission of the measurement waves and receiving of the return waves. In addition, the signal processing unit 111 performs a known process for the input beat signal to at least calculate the distance to the object. The signal processing unit 111 is normally capable of calculating the relative speed of the object and the direction at which the object is located, in addition to the distance to the object.

As described above in “Description of the Related Art”, it is difficult to detect an object located within a close range closer than or equal to several meters (for example, 1 m) with high accuracy with low cost configurations in general radar apparatuses in the related art.

Accordingly, in the radar apparatus of the present disclosure, the plate-shaped dielectric unit 19 that is made of a predetermined dielectric material and that has a uniform thickness is provided, for example, so as to cover the front faces of all the antenna elements composing the transmission antenna unit 13 and the front faces of all the antenna elements composing the receiving antenna unit 15. Here, for example, the dielectric unit 19 is disposed so as to abut against the front faces of all the antenna elements.

The front face of each antenna element is a portion opposed to the measurement range of the radar apparatus 1. When all the antenna elements are provided on the same substrate, the front faces of the antenna elements are equivalent to the face on which the antenna elements are formed on the substrate.

The dielectric material described above is, for example, glass epoxy resin having a relative permittivity of 4.0. Accordingly, since the dielectric unit 19 is capable of being made of the same material as that of other circuit substrates, this contributes a reduction in the cost of the radar apparatus 1.

The correction unit 113 may be part of the signal processing LSI described above or may be another integrated circuit. The correction unit 113 holds the relative permittivity and the thickness of the dielectric unit 19 in a memory 115 and corrects the distance to the object (that is, a detected distance) supplied from the signal processing unit 111 based on the information held therein.

### 2-2. Method of Calculating and Correcting Distance to Object

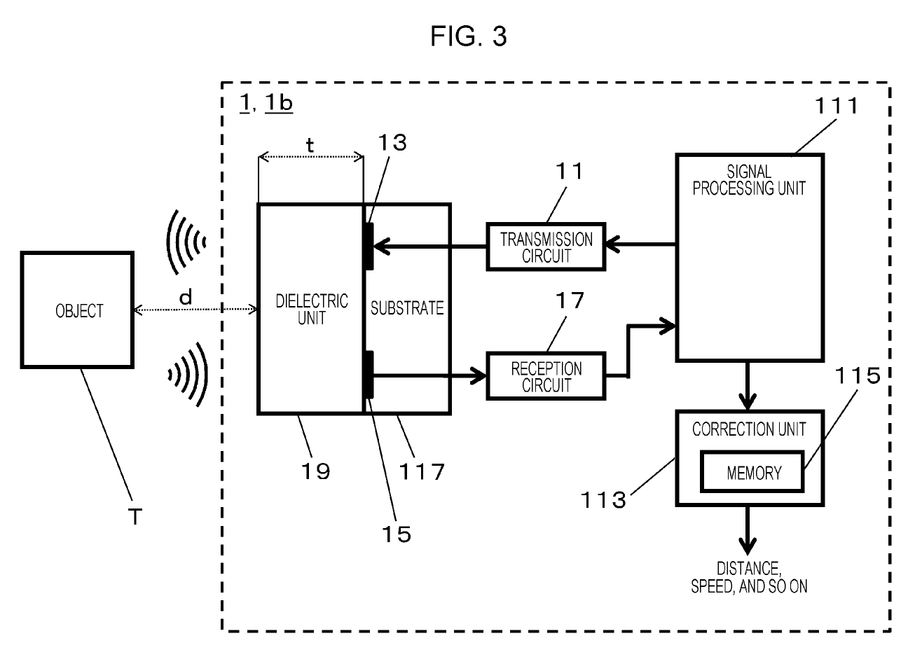

An exemplary method of calculating and correcting the distance to an object in the radar apparatus 1 will now be described with reference to FIG. 3.

In the radar apparatus 1 having the above configuration, as illustrated in FIG. 3, the transmission antenna unit 13 radiates the FMCW signal supplied from the transmission circuit 11 to the periphery of the radar apparatus 1 as the measurement waves, as described above. The radiated measurement waves are reflected from an object T that can be located within the measurement range of the radar apparatus 1. Part of the reflected waves is received by the receiving antenna unit 15 as the return waves.

A speed V of the measurement waves in the dielectric unit 19 is represented by Equation (1) when the measurement waves are the millimeter waves, where εᵣ denotes the relative permittivity of the dielectric unit 19.

$$v = \frac{c}{\sqrt{{ɛ}_{r}}} \qquad ( 1 )$$

A distance (hereinafter referred to as the detected distance) d′ from the front face of the dielectric unit 19 to the object T, which is calculated by the signal processing unit 111, is represented by Equation (2) where d denotes the actual distance from the front face of the dielectric unit 19 to the object T and t denotes the thickness of the dielectric unit 19.

d′=d+t·\sqrt{εᵣ} (2)

According to Equation (2), for example, when the actual distanced is 10 cm, the thickness t of the dielectric unit 19 is 2 cm, and the relative permittivity εᵣ of the dielectric unit 19 is 16, the detected distance d′ is 18 cm. Accordingly, the use of the radar apparatus 1 including the dielectric unit 19 when a range from 0 cm to 15 cm is not capable of being detected with a radar apparatus that does not include the dielectric unit 19 enables the object T that is located 10 cm away from the radar apparatus 1 to be detected.

However, since the actual distance d is 10 cm, the detected distance d′ calculated by the signal processing unit 111 is corrected by the correction unit 113. In the correction unit 113, the relative permittivity εᵣ (for example, εᵣ=16) and the thickness t (for example, t=2) are stored in advance in the memory 115.

Equation (2) indicates that the detected distance d′ calculated by the signal processing unit 111 is longer than the actual distance d by t×εᵣ^{0.5}. Accordingly, the correction unit 113 calculates the actual distanced according to Equation (3) upon receiving of the detected distance d′ calculated by the signal processing unit 111.

d=d′−t·\sqrt{εᵣ} (3)

For example, when the detected distance d′ is 18 cm, the thickness t of the dielectric unit 19 is 2 cm, and the relative permittivity εᵣ of the dielectric unit 19 is 16, the actual distance d is 10 cm.

In calculation of the actual distance from the transmission antenna unit 13 according to specifications or the likes of the radar apparatus 1, the correction unit 113 may add the thickness t of the dielectric unit 19 to the actual distance d resulting from the correction.

### 2-3. Effects and Advantages of Radar Apparatus

As described above, in the first embodiment, the plate-shaped dielectric unit 19 is provided so as to cover the front face of the transmission antenna unit 13 and the front face of the receiving antenna unit 15. In addition, the correction unit 113 corrects the detected distance d′ calculated by the signal processing unit 111 according to the above process to calculate the actual distance d. Since the radar apparatus 1 of the first embodiment is capable of detecting the object T located within a close range closer than or equal to several meter (for example, 1 m) owing to the provision of the dielectric unit 19 in the above manner, it is possible to configure the radar apparatus 1 at a low cost.

In Japanese Unexamined Patent Application Publication No. 2000-258525, a millimeter-wave oscillator is configured using a frequency stabilized Gunn oscillator and the carrier waves of a millimeter-wave band are modulated using a high-speed operating element, such as a FET or a high electron mobility transistor (HEMT), as described above. It is difficult to integrate this technology with the signal processing LSI composed of a CMOS. However, since it is sufficient to provide only the dielectric unit 19 in the first embodiment, it is easy to integrate the radar apparatus 1 with the signal processing LSI, such as a CMOS.

The technology in Japanese Unexamined Patent Application Publication No. 2000-258525 is suitable for the pulse system. However, in the first embodiment, the provision of the dielectric unit 19 facilitates the application to the FMCW system.

### 2-4. Note

Change of the thickness of the dielectric unit 19 or use of a material having a higher relative permittivity for the dielectric unit 19 enables the radar apparatus 1 to detect an object located within a closer range.

The application of the radar apparatus 1 to the FMCW radar is exemplified in the above embodiment. However, the application of the radar apparatus 1 is not limited to this and the radar apparatus 1 is applicable to the pulse system.

The signal processing unit 111 and the correction unit 113 may be realized by hardware or software.

The dielectric unit 19 covers both the transmission antenna unit 13 and the receiving antenna unit 15 in the above embodiment. However, the configuration of the dielectric unit 19 is not limited to this and it is sufficient for the dielectric unit 19 to cover at least one of the transmission antenna unit 13 and the receiving antenna unit 15.

The matters described in 2-4 apply to a second embodiment to a fourth embodiment.

### 3. Second Embodiment

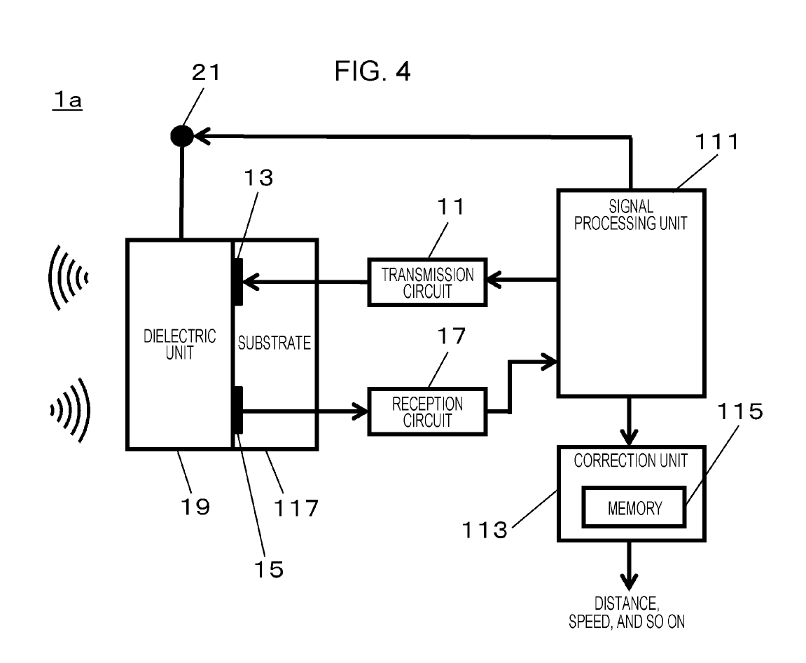

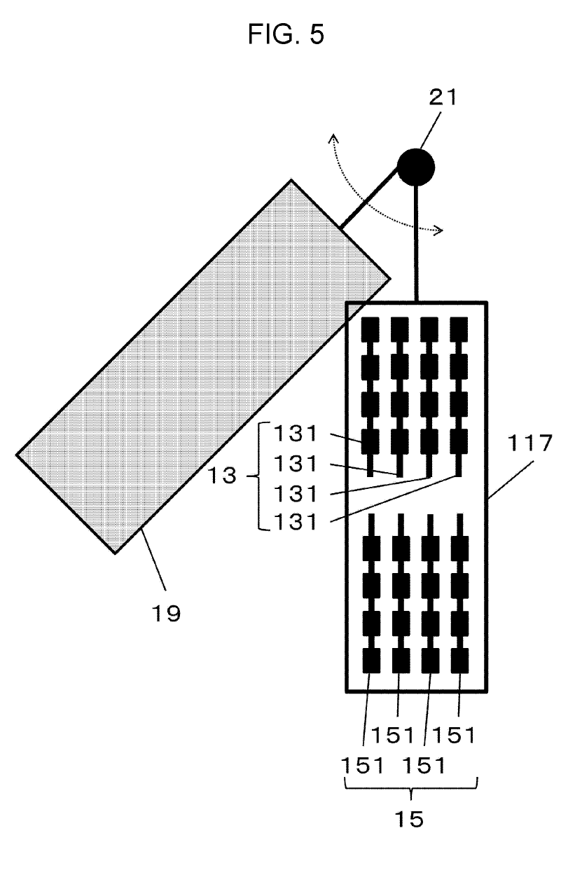

A radar apparatus 1a of a second embodiment of the present disclosure will now be described with reference to FIG. 4 and FIG. 5.

### 3-1. Configuration of a Radar Apparatus

Referring to FIG. 4 and FIG. 5, the radar apparatus 1a differs from the radar apparatus 1 described above in that the dielectric unit 19 is not fixed to the substrate 117 and in that a driving unit 21 that drives the dielectric unit 19 is further provided. The same reference numerals are used in FIG. 4 and FIG. 5 to identify the same components illustrated in FIG. 1 to FIG. 3. A description of such components is omitted herein.

When a vehicle is parked or is driving in a traffic jam, for example, when the speed of the vehicle is lower than a predetermined speed, the signal processing unit 111 detects the object T located within the close range, which is a range closer than or equal to a predetermined distance (closer than or equal to several meters (for example, 1 m). Accordingly, the signal processing unit 111 transmits a first control signal indicating the close range is used as the measurement range to the driving unit 21. Although the determination of whether the vehicle is parked or is driving in a traffic jam or the determination of whether the speed of the vehicle is lower than the predetermined speed may be performed by the signal processing unit 111, the signal processing unit 111 may receive a result determined in the outside of the radar apparatus 1a.

In contrast, when a vehicle is driving on a highway, for example, when the speed of the vehicle is higher than or equal to the predetermined speed, the signal processing unit 111 detects the object T located within a far range, which is a range farther than the predetermined distance (exceeding several meters (for example, 1 m). Accordingly, the signal processing unit 111 transmits a second control signal indicating the far range is used as the measurement range to the driving unit 21. Although the determination of whether the vehicle is driving on a highway or the determination of whether the speed of the vehicle is higher than or equal to the predetermined speed may be performed by the signal processing unit 111, the signal processing unit 111 may receive a result determined in the outside of the radar apparatus 1a. In this case, the signal processing unit 111 does not supply the calculated distance to the object T to the correction unit 113.

The driving unit 21 turns the dielectric unit 19 in response to receiving of the first control signal to cause the dielectric unit 19 to cover the front of the transmission antenna unit 13 and the front of the receiving antenna unit 15 I, as illustrated in FIG. 5.

In contrast, the driving unit 21 turns the dielectric unit 19 so that the front of the transmission antenna unit 13 and the front of the receiving antenna unit 15 are not covered with the dielectric unit 19 (that is, the front of the transmission antenna unit 13 and the front of the receiving antenna unit 15 are not blocked) in response to receiving of the second control signal.

### 3-2. Effects and Advantages of Radar Apparatus

As described above, the radar apparatus 1a of the second embodiment not only has the effects and advantage similar to those of the radar apparatus 1 but also is capable of detecting the object T that can be located within the far range. Accordingly, it is possible to provide the more user-friendly radar apparatus 1a.

In addition, since the dielectric unit 19 does not cover the front of the transmission antenna unit 13 and the front of the receiving antenna unit 15 when the far range is used as the measurement range, it is possible to reduce the reflection and/or loss by the dielectric unit 19, thus increasing the measurement distance.

### 3-3. Note

Whether the close range is used as the measurement range or the far range is used as the measurement range may be determined based on at least one of the steering angle, the vehicle speed, the shift position, and user settings.

The matters described in 3-3 apply to a third embodiment described below.

### 4. Third Embodiment

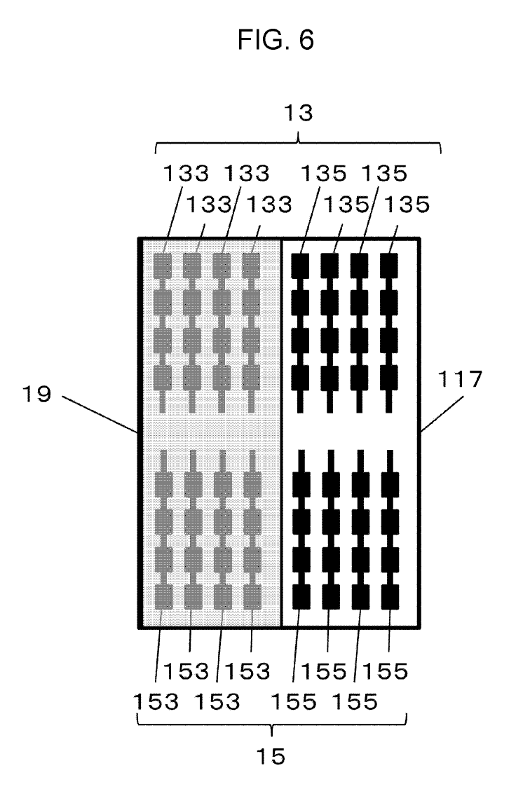

A radar apparatus 1b of a third embodiment of the present disclosure will now be described with reference to FIG. 6.

4-1. Configuration of radar apparatus

Referring to FIG. 6, the radar apparatus 1b differs from the radar apparatus 1 described above in that the transmission antenna unit 13 includes first transmission antennas 133 and second transmission antennas 135 and the receiving antenna unit 15 includes first receiving antennas 153 and second receiving antennas 155 and in that the dielectric unit 19 constantly covers the fronts of the first transmission antennas 133 and the first receiving antennas 153. FIG. 1 and FIG. 3 are incorporated in the third embodiment.

Each of the first transmission antennas 133 and the second transmission antennas 135 is an antenna array each including multiple antenna elements and is provided on the main face of the substrate 117. In the example in FIG. 6, each of the first transmission antennas 133 and the second transmission antennas 135 includes four antenna branches.

Each of the first receiving antennas 153 and the second receiving antennas 155 is an antenna array each including multiple antenna elements and is provided on the main face of the substrate 117. In the example in FIG. 6, each of the first receiving antennas 153 and the second receiving antennas 155 includes four antenna branches.

For example, when the speed of a vehicle is lower than a predetermined speed, the signal processing unit 111 detects the object T located within the close range. The signal processing unit 111 radiates the measurement waves from the first transmission antennas 133 in order to use the close range as the measurement range. The close range and the far range in the third embodiment are the same as the ones described in the second embodiment.

When the close range is used as the measurement range, the signal processing unit 111 at least calculates the distance to the object T using the FMCW signals supplied to the first transmission antennas 133 and the signals output from the first receiving antennas 153 and supplies a signal concerning the calculated distance to the correction unit 113.

In contrast, for example, when the speed of the vehicle is higher than or equal to the predetermined speed, the signal processing unit 111 detects the object T located within the far range. The signal processing unit 111 radiates the measurement waves from the second transmission antennas 135 in order to use the far range as the measurement range.

When the far range is used as the measurement range, the signal processing unit 111 at least calculates the distance to the object T using the FMCW signals supplied to the second transmission antennas 135 and the signals output from the second receiving antennas 155. In this case, the signal processing unit 111 does not supply a signal concerning the calculated distance to the object T to the correction unit 113.

### 4-2. Effects and Advantages of Radar Apparatus

As described above, the radar apparatus 1b of the third embodiment not only has the effects and advantage similar to those of the radar apparatus 1 but also is capable of detecting the object T that can be located within the far range. Accordingly, it is possible to provide the more user-friendly radar apparatus 1b.

In addition, since it is possible to reduce the reflection and/or loss by the dielectric unit 19, as in the second embodiment, when the far range is used as the measurement range, the measurement distance is increased.

### 5. Fourth Embodiment

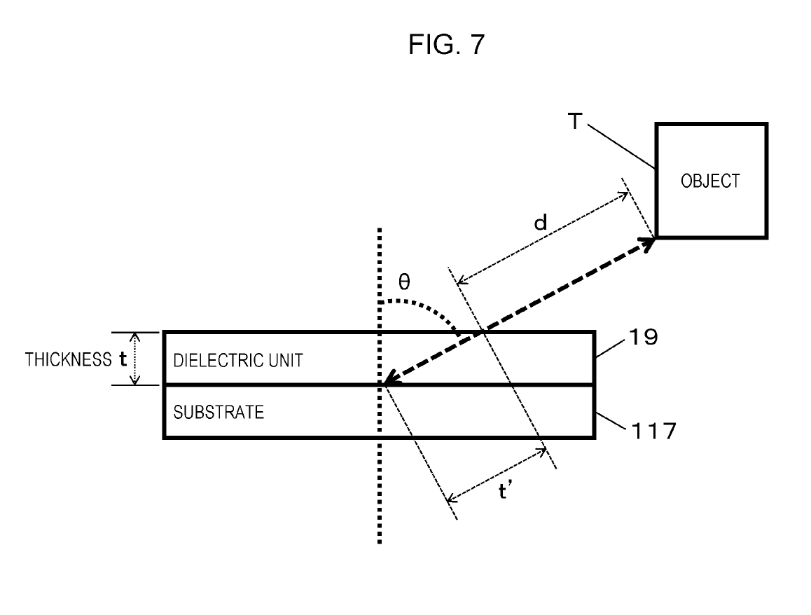

In the first to third embodiments described above, the object T detected by the radar apparatuses 1, 1a, and 1b may be located at a azimuth angle θ with respect to the normal direction of the front faces of the antenna elements, as illustrated in FIG. 7. In other words, the return waves reach the radar apparatuses 1, 1a, and 1b at the azimuth angle θ. In this case, the correction unit 113 corrects the distance to the object T in the following manner.

As illustrated in FIG. 7, when the object T is located at the actual distance d and at the azimuth angle θ with respect to the normal direction of the front faces of the antenna elements, the measurement waves and the return waves pass through the dielectric unit 19 at an angle θ. Accordingly, a physical length t′ at which the measurement waves and the return waves pass through the dielectric unit 19 is represented by Equation (4):

t=t′·cos θ (4)

Accordingly, upon confirmation that the object T is located at the azimuth angle θ using a known method, the correction unit 113 calculates the actual distance d to the object T according to Equation (5):

$$d = {d}^{′} - \frac{t}{cos θ} \cdot \sqrt{{ɛ}_{r}} \qquad ( 5 )$$

For example, if the signal processing unit 111 detects that the detected distance d′ to the object T is 26 cm and the direction of the object T is 60° when the thickness t of the dielectric unit 19 is 2 cm and the relative permittivity εᵣ thereof is 16, the actual distance d is corrected so as to be 10 cm.

In calculation of the actual distance from the transmission antenna unit 13 according to the specifications or the likes of, for example, the radar apparatus 1, the correction unit 113 may add the physical length t′ (=2 cm/cos 60°) in the dielectric unit 19 to the actual distance d resulting from the correction.

The present disclosure may be realized by software, hardware, or software in cooperation with hardware.

Each functional block used in the description of each embodiment described above may be partly or entirely realized by an LSI such as an integrated circuit, and each process described in the each embodiment may be controlled partly or entirely by the same LSI or a combination of LSIs. The LSI may be individually formed as chips, or one chip may be formed so as to include part or all of the functional blocks. The LSI may include a data input and output coupled thereto. The LSI here may be referred to as an IC, a system LSI, a super LSI, or an ultra LSI depending on the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure may be realized as digital processing or analog processing.

If future integrated circuit technologies replace LSIs as a result of the advancement of the semiconductor technology or other derivative technologies, the functional blocks may be integrated using the future integrated circuit technologies. Biotechnology can also be applied.

The radar apparatus of the present disclosure is capable of being configured at a lower cost and is applicable to in-vehicle applications and so on.

What is claimed is:

1. A radar apparatus comprising:
a transmission antenna that radiates measurement waves to a certain direction;
a receiving antenna that receives return waves from one or more objects around the radar apparatus;
a dielectric that covers at least one of a front of the transmission antenna and a front of the receiving antenna;
a signal processor that at least calculates a distance to the one or more objects based on the return waves; and
a corrector that corrects the distance based on a relative permittivity and a thickness of the dielectric.

2. A radar apparatus comprising:
a transmission antenna that radiates measurement waves to a certain direction;
a receiving antenna that receives return waves from the one or more objects around the radar apparatus;
a dielectric;
a signal processor that at least calculates a distance to the one or more objects based on the return waves;
a corrector that corrects the distance based on a relative permittivity and a thickness of the dielectric; and
a driver that drives the dielectric so that the dielectric covers at least one of a front of the transmission antenna and a front of the receiving antenna when the one or more objects located within a close range closer than or equal to a predetermined distance is measured and so that the dielectric does not cover the front of the transmission antenna and the front of the receiving antenna when the one or more objects located within a far range farther than the predetermined distance is measured.

3. The radar apparatus according to claim 1,
wherein the transmission antenna includes a first transmission antenna and a second transmission antenna,
wherein the receiving antenna includes a first receiving antenna and a second receiving antenna,
wherein the dielectric covers at least one of a front of the first transmission antenna and a front of the first receiving antenna,
wherein, when the one or more objects located within a close range closer than or equal to a predetermined distance is measured, the signal processor calculates the distance to the one or more objects based on the received return waves in the first receiving antenna of the measurement waves transmitted from the first transmission antenna and the corrector corrects the distance based on the relative permittivity and the thickness of the dielectric, and
wherein, when the one or more objects located within a far range farther than the predetermined distance is measured, the signal processor calculates the distance to the one or more objects based on the received return waves in the second receiving antenna of the measurement waves transmitted from the second transmission antenna.

4. The radar apparatus according to claim 1,
wherein the corrector corrects the distance based on the relative permittivity and the thickness of the dielectric and a direction from which the return waves reach the radar apparatus.
